(19) United States
(12) Patent Application Publication
(10) Pub. No.: US 2019/0068527 A1
(43) Pub. Date: Feb. 28, 2019

(54) METHOD AND SYSTEM FOR CONDUCTING AN AUTOMATED CONVERSATION WITH A VIRTUAL AGENT SYSTEM

(71) Applicant: MOVEWORKS, INC., Freemont, CA (US)

(72) Inventors: Jiang CHEN, Fremont, CA (US); Vachan WODEYAR, San Jose, CA (US); Vaibhav NIVARGI, Mountain View, CA (US); Varun SINGH, San Francisco, CA (US)

(21) Appl. No.: 15/688,190

(22) Filed: Aug. 28, 2017

(51) Int. Cl. H04L 12/58; G06F 17/27; G06N 7/00

(52) U.S. Cl. CPC H04L 51/02; G06N 7/005; G06F 17/2785; H04L 51/16

(57) ABSTRACT

A computer-implemented method for conducting a conversation with a virtual agent system is provided. The method includes receiving a conversation input from a user during a conversation of the user with a virtual agent system. The method includes probabilistically matching the conversation input with a stack of earlier conversations between the user and the virtual agent system. The probabilistic matching determines a context of the conversation input from one or more contexts associated with the stack of earlier conversations. The method includes interpreting the conversation input to identify a user intent from among a plurality of user intents. The method further includes determining an action to be performed by the virtual agent system based on the context determined by the probabilistic matching and the user intent.

### TECHNICAL FIELD

Embodiments of the disclosure relate generally to conversational interfaces and, more particularly to, methods and systems for context switching in conversational interfaces.

### BACKGROUND

Most product and services entities nowadays facilitate conversational interfaces for interaction with customers via online platforms. Entities offering services, products, etc., over the internet, implement chatbots or virtual agents for intelligent conversations with users for various practical purposes such as customer service and information delivery.

An interactive dialog between a user and a chatbot/virtual agent is referred to as a chat session. Users post questions to the chatbots, for which the chatbots provide answers. Likewise, the chatbots ask questions to users and receive answers from users. The answers that the user receives from the chatbots are preprogrammed into the chatbot. The chatbots are trained on huge corpuses of inputs received from users in order to modify the chatbot's responses, which enhances customer experience while chatting.

Existing conversational interfaces use either a ‘one-shot’ approach or a ‘slot filling’ approach for dialog management. One shot approach tries to return the exact response for the user's question/message and does not support posting of any follow up questions from the chatbot to the user. As an example, for a query like ‘what is a good place for late night dinner in Mountain view?’, a chatbot may reply with one or more suggestions. The thread of the conversation ends at that point with the chatbot providing the suggestions, thereby relying on the human user to either pick one of the suggested places, or wait for the human user to rephrase the question. This is of limited utility since in most cases it is very difficult to have all the required information through a single response from the chatbot when the chatbot does not support additional follow up messages/questions.

Slot filling approach, on the other hand, utilizes an understanding of the required bits of information for performing an action, and expressly delivering follow up questions until those bits of information are deemed to be present. As an example, for ordering a pizza using a chatbot, it needs information about pizza base, size, toppings, delivery or pickup. Some of these are mandatory and others may be optional. A slot filling based conversational interface would ask subsequent questions until all the mandatory questions have answers, and in some cases refuse to proceed until all of them are filled. This leads to poor user experience and is a very restrictive way of modeling conversations.

In some conventional conversational interfaces, the one shot approach has been improved with a multi turn type conversation in order to enhance user experience. A multi turn type conversation interface enables a human user to post additional questions to the chatbot while maintaining the current context/topic. However, unless the user completes the current context or abandons it (e.g. by saying ‘Cancel’ or ‘Abort’), there is no way to proceed to a new one. Similarly, once proceeded, it's almost impossible to invoke an earlier context.

It is routine for conversing humans to talk about several topics at the same time without having to explicitly tie the conversation to one topic. However, conventional conversational interfaces do not support topic/context switching in ongoing conversations with a chatbot in a similar way as how human beings communicate.

In light of the above discussion, there appears to be need for conversational interfaces that support topic/context switching in ongoing conversations.

### SUMMARY

Various embodiments of the present disclosure provide systems and methods for conducting a conversation with a virtual agent system.

An embodiment provides a computer-implemented method for conducting a conversation with a virtual agent system. The method includes receiving a conversation input from a user during a conversation of the user with a virtual agent system. The method includes probabilistically matching the conversation input with a stack of earlier conversations between the user and the virtual agent system. The probabilistic matching determines a context of the conversation input from one or more contexts associated with the stack of earlier conversations. The method includes interpreting the conversation input to identify a user intent from among a plurality of user intents. The method further includes determining an action to be performed by the virtual agent system based on the context determined by the probabilistic matching and the user intent.

Another embodiment provides a system for conducting an automated conversation with a virtual agent system. The system includes a memory configured to store instructions. The memory further stores at least one intent model. The system includes a processor configured to execute the stored instructions to cause the system to at least perform receiving a conversation input from a user during a conversation of the user with a virtual agent system. The system is further caused to probabilistically match the conversation input with a stack of earlier conversations between the user and the virtual agent system. The probabilistic matching determines a context of the conversation input from one or more contexts associated with the stack of earlier conversations. The system is further caused to perform interpreting the conversation input to identify a user intent from among a plurality of user intents. The system is further caused to perform determining an action to be performed by the virtual agent system based on the context determined by the probabilistic matching and the user intent.

Another embodiment comprises a computer program product including a computer readable storage medium and including computer executable code for a virtual agent system. The computer executable code is executed by a processor. The computer program product includes one or more instructions. The instructions cause the virtual agent system to receive a conversation input from a user during a conversation of the user with a virtual agent system. The instructions further cause the virtual agent system to probabilistically match the conversation input with a stack of earlier conversations between the user and the virtual agent system. The probabilistic matching determines a context of the conversation input from one or more contexts associated with the stack of earlier conversations. The instructions cause the virtual agent system to interpret the conversation input to identify a user intent from among a plurality of user intents. The instructions further cause the virtual agent system to determine an action to be performed by the virtual agent system based on the context determined by the probabilistic matching and the user intent.

### BRIEF DESCRIPTION OF THE FIGURES

For a more complete understanding of example embodiments of the present technology, reference is now made to the following descriptions taken in connection with the accompanying drawings in which:

FIG. 1 is a simplified illustration of an environment in which a system, for conducting a conversation with a virtual agent system, is deployed, in accordance with some embodiments;

FIG. 2 is a simplified block diagram of the virtual agent system, in accordance with an example embodiment;

FIG. 3 is a simplified illustration of an intent model, in accordance with an example embodiment;

FIG. 4 is an illustration of a chatbot system dialog interface facilitating conversation between a user and the virtual agent system, in accordance with an example embodiment;

FIG. 5 is an illustration of stack of earlier conversations stored in a database, in accordance with an example embodiment;

FIG. 6 is a flowchart illustrating a method for conducting a conversation with a virtual agent system, in accordance with an example embodiment;

FIG. 7 illustrates another flowchart showing the method for conducting a conversation with a virtual agent system, in accordance with an example embodiment;

FIG. 8 is a block diagram of a device which may be an example of the a user device; and

FIG. 9 is a simplified block diagram of a server, in accordance with one embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide systems and methods conducting a conversation with a virtual agent system.

An embodiment provides a system and a method for conducting a conversation with a virtual agent/chatbot system. The system may include a virtual agent/chatbot system that intelligently interacts with a user of a user device. The virtual agent system and its components may rest at a server. The virtual agent system may be integrated with a website or a digital platform associated with an entity. The user may browse the website and communicate with the chatbot system via a chatbot dialog interface in order to enquire about products and services offered by the entity. A user uses his/her user device to establish a chat session with the chatbot system networks such as the Internet. User represents a customer visiting a website over the Internet and commencing a chat session with chatbot system.

The virtual agent/chatbot system may include a memory/storage and a processor. The memory includes one or more databases for storing at least one intent model. The intent model includes a plurality of user intents. Each user intent represents a taxonomy or a class into which a conversation input from a user may be classified. The virtual agent system receives conversation inputs from the user, through the user device, for conducting conversation with the virtual agent system. Conversation inputs received from the user device may be stored within the one or more databases. The processor of the virtual agent system includes a natural language processor configured to parse the input to extract on or more data strings defined in the intent model. The parsed data is interpreted to identify a user intent from among a plurality of user intents, wherein the identified user intent is one among the plurality of user intents stored in the intent model. The one or more databases further store predefined number of earlier conversations, thereby forming a stack of earlier conversations. The stack of earlier conversations includes a predefined number of conversations related to one or more contexts. The processor of the virtual agent system includes a probabilistic matching algorithm, which is configured to probabilistically match the conversation input with one or more contexts associated with the stack of earlier conversations. The probabilistic matching may determine if an input relates to a context in the stack of earlier conversations. Based on the probabilistic matching and the user intent, the virtual agent system either performs an activity indicated by the conversation input or responds to the conversation input. The user device communicates with the virtual agent system through communication networks.

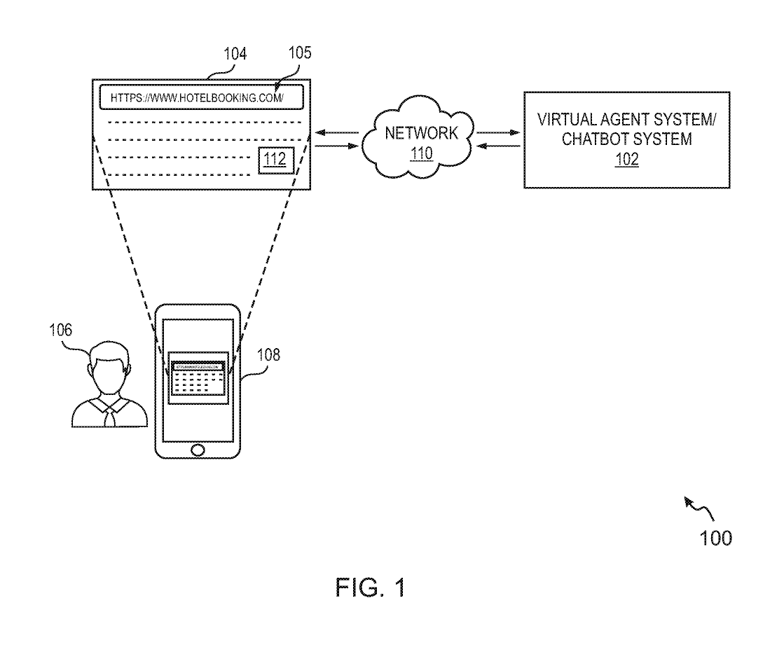

FIG. 1 is a simplified illustration of an environment in which a system 100, for conducting an automated conversation with a virtual agent, is deployed, in accordance with some embodiments as disclosed herein. The system 100 includes a virtual agent system/chatbot system 102. The chatbot system 102 may be integrated with digital platforms of a plurality of entities. A non-exhaustive example of the digital platform may include a website 104 that is associated with an entity or is hosted by the entity. Some examples of the entity may be a merchant, a retailer or any entity facilitating a digital platform for offering goods and services to customers. The website 104 is displayed upon a user 106 entering a web uniform resource locator (URL), associated with the website 104, at a space 105 provided in a web browser using a user device 108. The terms “chatbot” and “virtual agent” are interchangeably used throughout the disclosure. Further, the terms “chatbot system” and “virtual agent system” are interchangeably used throughout the disclosure.

The user 106 utilizes the user device 108 to communicate with the chatbot system 102. In some embodiments, the user device 108 may be a portable communication device. Examples of portable user device 108 include, but are not limited to, a tablet device, a personal digital assistant (PDA), a smart phone and a laptop, among others. In some embodiments, the user device 108 may be a non-portable communication device. Examples of non-portable user device 108 include a personal computer (PC) and a kiosk, among others. The user device 108 may be a device that the user (e.g. the user 106) operates to browse the website 104 and to establish a chat session with the chatbot system 102 integrated with the website 104. The user 106 represents a customer visiting a website (e.g. 104) over the Internet (see 110), and commencing a chat session with the chatbot system 102.

The user device 108 communicates with the chatbot system 102 via the communication network 110 such as the Internet. The communication network 110 represents any distributed communication network (wired, wireless or otherwise) for data transmission and receipt between/among two or more points. The network 108 may as an example, include standard and/or cellular telephone lines, LAN or WAN links, broadband connections (ISDN, Frame Relay, ATM), wireless links, and so on. Preferably, the network 108 can carry TCP/IP protocol communications, and HTTP/HTTPS requests made by the user device 104 and the connection between the user device 104 and the centralized server 102 can be communicated over such networks 108. In some implementations, the network 108 includes various cellular data networks such as 2G, 3G, 4G, and others. The type of network 108 is not limited, and the network 108 may include any suitable form of communication. Typical examples of the network 108 includes a wireless or wired Ethernet-based intranet, a local or wide-area network (LAN or WAN), and/or the global communications network known as the Internet, which may accommodate many different communications media and protocols.

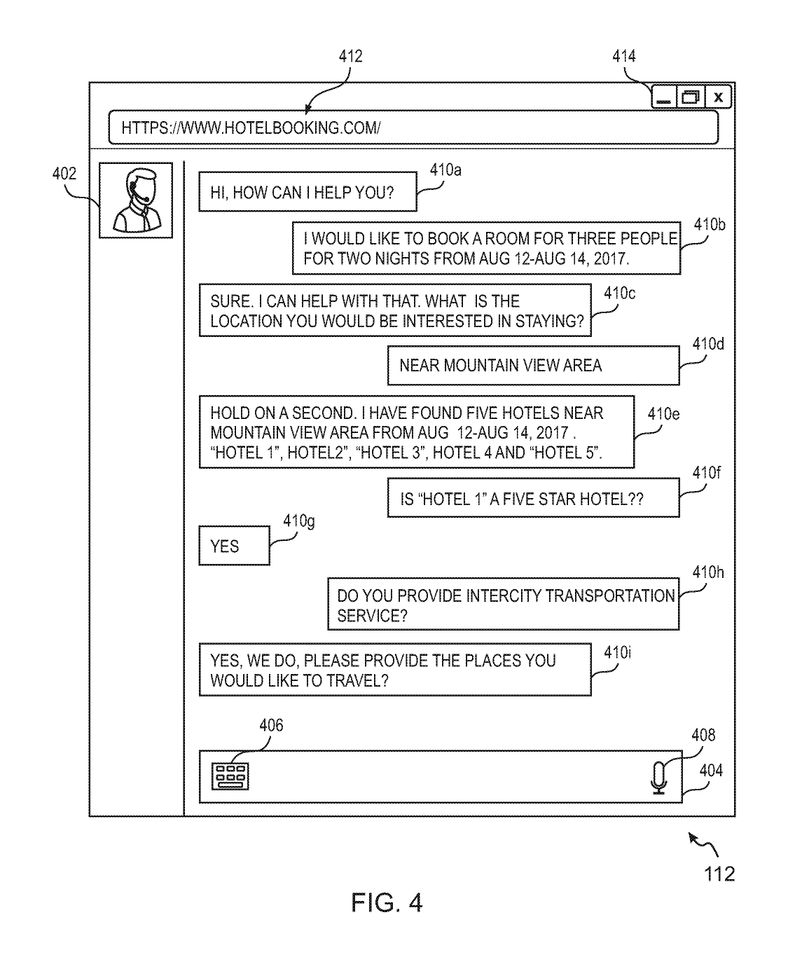

The chatbot system 102 facilitates a chatbot system dialog interface 112 at the website 104. The chatbot system dialog interface 112 may be in a minimized form of display initially, as seen in FIG. 1. The chatbot system 102 may provide an option, such as actionable icon/button (414 shown in FIG. 4) that enable maximizing the chatbot system dialog interface 112 from a minimized display. The actionable icon 414 also facilitates minimizing the chatbot system dialog interface 112 from a maximized form of display. The actionable icon 414 further facilitates closing the display of the chatbot system dialog interface 112. Selection of the icon 414 may facilitate the chatbot system dialog interface 112 as a pop up interface. Further, selection of the icon 414 may facilitate the chatbot system dialog interface 112 as an overlay interface over the pages of the website 104.

The communication between the user device 108 and the chatbot system 102 occurs when the user 106 browses the website 104 and initiates a chat session with the chatbot system 102 by providing a conversation input in the form of voice or text through the chatbot system dialog interface 112. The chatbot system dialog interface 112 may be preconfigured at the website 104. The virtual agent system dialog interface 112 is made available at the user device 108 while the user 106 utilizes the user device 108 to communicate with the virtual agent system 102, while browsing the website 104.

A plurality of users 106 can concurrently communicate with the chatbot system 102 while visiting websites, such as the website 104. As seen in FIG. 1, the user 106 utilizes the user device 108 such as a smart phone for communicating with the chatbot system 102. Consequently, the user 106 browsing the website 104 can learn about products and/or services offered by the corresponding entity of the website by communicating with the chatbot system 102 via the chatbot system dialog interface 112.

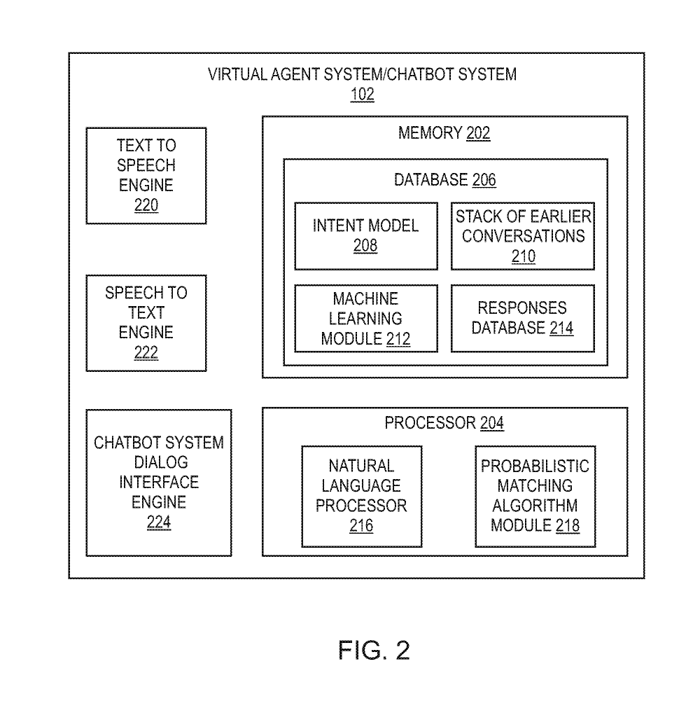

FIG. 2 is a simplified illustration of the virtual agent system/chatbot system 102, in accordance with an embodiment. The virtual agent system/chatbot system 102 may include a memory 202 and a processor 204. The memory 202 includes one or more databases 206. In FIG. 2, the memory 202 includes one database 206. The database 206 stores at least one intent model 208 and a stack of earlier conversations 210.

The stack of earlier conversations 210 may also be interchangeably referred to as a log of earlier conversations 210 in the present disclosure. The stack of earlier conversations 210stores a predefined number of historical conversations or chats corresponding to a chat session. In an example, the stack of earlier conversations 210 may include a log of an ongoing conversation between the user 106 and the chatbot system 102. Additionally, the stack of earlier conversations 210 may include a log of past conversations between the user 106 and the chatbot system 102.

In an embodiment, the predefined number of chats or conversations may correspond to one or more contexts. The interaction between the chatbot system 102 and the user 106 via the chatbot system dialog interface 112 allows the database 206 to store and process a plurality of combinations of conversation inputs (messages, questions, etc) as contexts in the stack of earlier conversation 210, which may be used for future conversations.

Conversation inputs are also referred to as “inputs” and “input messages” throughout the disclosure. Inputs or input messages within the disclosure refer to text messages, audio messages or audio-video messages provided by the user 106. The inputs are stored in the intent model 208. In an embodiment, initially a plurality of input messages may be preconfigured into the intent model 208 of the database 206. The inputs include questions, answers to questions posted by the virtual agent system 102, requests and commands to perform an action, among others. The intent model 208 stores a plurality of user intents. The intent model 208 further stores parsed data corresponding to the conversation inputs. The plurality of user intents may represent a taxonomy or a class into which one or more conversation inputs may be classified. Further, a plurality of conversation inputs may be classified into one user intent included in the intent model 208.

The memory 202 includes a responses database 214. Responses are interchangeably referred to as “response messages” throughout the disclosure. Responses or response messages within the disclosure refer to text messages, audio messages or audio-video messages provided by the chatbot system 102 in response to input messages received from the user 106. A plurality of response messages may be preconfigured into the response database 214. Responses received from the virtual agent system 102 may include questions and answers to questions posted by the user 106. The response database 214 may be updated frequently based on training of the chatbot system 102 on a plurality of inputs and responses.

Responses are generated by the chatbot system 102 based on the user intent, according to a certain set of instructions. For example, an initial response message such as “Hi, how may I help you?” may be a special response message, which may be generated based on the user's action of browsing the website 104 or selecting (by clicking/pressing a button) the chatbot system dialog interface 112 at the website 104.

The inputs may be in the form of texts and/or audio. Audio input may include utterances, such as, sentences indicating a question or answer to a question. Likewise, the responses may be in the form of texts and/or utterances. Responses may include sentences indicating a question or answer to a question.

In an embodiment, the chatbot system 102 may include a machine learning module 212. The processor 204 may enable the machine learning module 212 to train the chatbot system 102 on huge corpuses of data (conversation inputs and response messages) in order to enable the chatbot system 102 to present modified responses to the user 106.

The processor 204 further includes a natural language processor 216 and a probabilistic matching algorithm module 218. The processor 204 may be a general purpose processor, a special purpose processor or graphical unit processor. The processor 204 may be a combination of one or more processing units (CPU). The natural language processor 216 may be configured to parse the input message and extract one or more data strings. The one or more data strings are used to interpret the user intent at the intent model 208. Based on the interpretation, the input may be classified into a relevant user intent taxonomy. The relevant user intent may further be stored within the intent model 208.

The virtual agent system 102 includes a text to speech engine 220 and a speech to text engine 222. In an embodiment, the text to speech engine 220 and the speech to text engine 222 may be embodied within the natural language processor 216. The virtual agent system 102 further includes a chatbot dialog interface engine 224. The chatbot dialog interface engine 224 facilitates the chatbot system dialog interface 112 (shown in FIG. 1 and FIG. 4) at the website 104.

The virtual agent system 102 may be a set of computer executable codes stored within a server. The virtual agent system 102 may be made available at the website 104 in order to facilitate conversation with the user 106 who browses the website 104. The virtual agent system 102 may be an application resting at the server. The server may be a remote virtual server such as a cloud server. Alternatively or additionally, the chatbot system 102 might be installed as a stand-alone application on a stand-alone device, such as the user device 108. The standalone application may enable the user device 108 to establish a chat session with the chatbot system 102, as the website 104 is browsed using the user device 108.

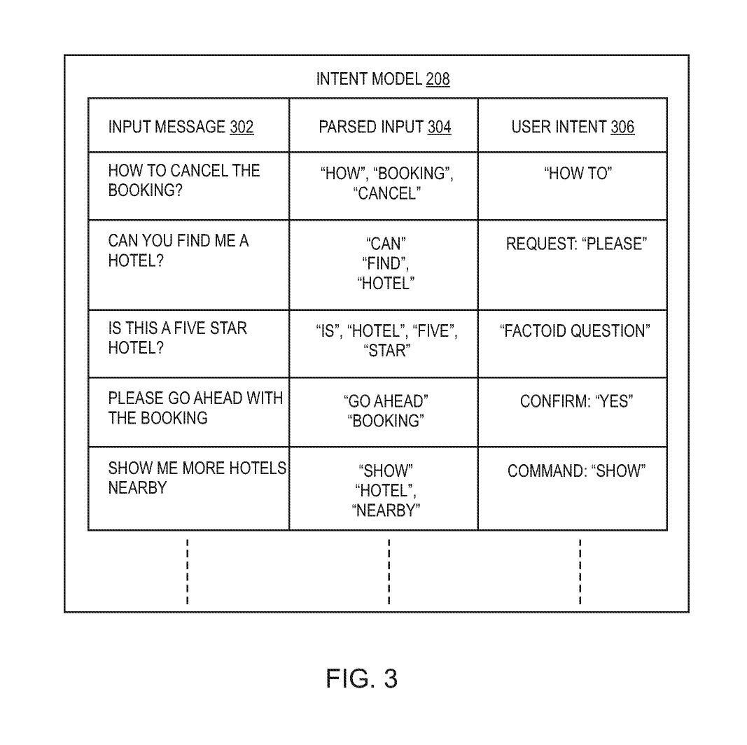

FIG. 3 is a simplified illustration of the example intent model 208, in accordance with an example embodiment. Example illustration of the intent model 208 includes a table 300 including three columns 302, 304 and 306 and a plurality of rows, wherein each column 302, 304, 306 stores conversation inputs, the parsed data corresponding to the conversation inputs and the corresponding user intents, respectively. It shall be noted that the representation of the intent model 208 as shown in FIG. 3 is exemplary and only for the purposes of explanation. The data stored in the intent model 208 may be in a different format (well-known in the art) from that of the illustration of FIG. 3. The intent model 208 may be in operative communication with the natural language processor 216, the text to speech engine 220 and the speech to text engine 222. The input messages are parsed (not shown) at the natural language processor 216 to extract one or more data strings. The utterances are converted to texts and stored in the intent model 208. Similarly, the text inputs are converted to utterances and stored in the intent model 208. It shall further be noted that a plurality of inputs may be classified into or mapped to one user intent included in the intent model 208.

As shown in FIG. 3, the column 302 stores input messages in each of the corresponding rows of the table 300. The input messages may be, as an example, questions starting with interrogative words such as “How”, “Can”, “Do”, “What”, etc. Further, input messages can be any question for which the answer is a simple “Yes” or “No”. Furthermore, input messages can be a request having the word “Please” in it. Furthermore, input messages can be a command, such as, “show me”, “find me”, etc, which might require the chatbot system 102 to perform an action. Examples of input messages may be “How to cancel my booking?”, “How do I place the order?”, “Can you find me a hotel?”, “Show me more hotels nearby”, “Please go ahead with the booking”, etc.

The column 304 stores parsed data in each of the corresponding rows of table 300. The input messages in column 302 may be parsed at the natural language processor 216 to extract data strings. Data strings may be stored as shown in FIG. 3 in the rows of column 304. The data strings may include characters that are present in the input messages. As an example, the input message “How to cancel my booking?” may be parsed into three data strings, “How”, “cancel”, “booking”. Likewise, the input message “Can you find me a hotel?” may be parsed into three data strings, “can”, “find”, “hotel”, and so on.

The column 306 stores user intents in each of the corresponding rows of table 300. The parsed data may be used to interpret the relevant user intent included in the intent model 208. The relevant user intent may be stored in the column 306 next to the parsed data (data strings) as shown in FIG. 3. As an example, the data strings “How”, “cancel”, “booking” corresponding to input “How to cancel my booking?” may be used to interpret a user intent “how to”. The input “How to cancel my booking?” may subsequently be classified into user intent “how to”. Likewise, the data strings “can”, “find”, “hotel” corresponding to input message “Can you find me a hotel?” may be used to interpret a user intent “please” and the input “Can you find me a hotel?” may be classified into user intent “please”, and so on.

The machine learning module 212 trains the chatbot system 102 on a plurality of inputs and responses. The plurality of inputs and responses may be periodically provided by entities hosting websites such as the website 104, integrated with the chatbot system 102 by posting input messages through the chatbot system dialog interface 112. The machine learning module 212 is configured to extract rules and patterns from sets of data (input messages and responses). The machine learning module 212 maps an input to a response based on the rules and patterns. One or more input messages associated with a single context or a similar context may be identified and one or more relevant user intents may be interpreted. Similarly, relevant responses are generated for the plurality of input messages associated with different contexts. Furthermore, relevant responses are generated for one or more input messages associated with slightly similar contexts. The generated responses are stored at the responses database 214. The generated responses may replace or overwrite existing responses at the responses database 214.

FIG. 4 is a simplified illustration of an example chatbot system dialog interface 112, in accordance with an example embodiment. The chatbot system 102 includes a graphical image 402 representing the chatbot system dialog interface 112. The graphical image 402 represents, without limitation, an avatar, a talking head or a virtual assistant. The graphical image 402 may be displayed at the website 104 when the user selects the chatbot system dialog interface 112 to interact with the chatbot system 102.

As seen in FIG. 4, the chatbot system dialog interface 112 facilitates a field 404 where the user 106 may type input messages in form of texts. The field 404 provides an actionable icon 406. Selection (e.g., by clicking, pressing or tapping) of the actionable icon 406 further facilitates a virtual keypad/keyboard as an overlay interface on the chatbot system dialog interface 112. Further, the field 404 provides an actionable icon 408. Selection of the actionable icon 408 further activates a microphone, thereby activating a voice input sensor of the user device 108 responsible for receiving voice input. After selection of the actionable icon 408, the voice input sensor remains active for a predefined duration within which the voice input sensor can receive utterances from the user 106.

The chatbot system dialog interface 112 further includes message boxes exemplarily shown as boxes 410a-410i. In the illustrated example, the message boxes 410b, 410d, 410f and 410h represent input messages received from the user 106 through user device 108. The message boxes 410a, 410c, 410e, 410g and 410i represent response messages received from the chatbot system 102. It shall be noted that the message included in the message box 410a may be a special message, which may be generated based on a user's action of browsing the website 104 or selecting (by clicking/pressing a button) the chatbot system dialog interface 112 on the website 104. It shall further be noted that the message boxes 410a-410i may not necessarily appear in the same order displayed in FIG. 4. In some scenarios, the chatbot system 102 may post one or more response messages consecutively. Likewise, in some scenarios, the user 106 may post one or more input messages, consecutively. The field 412 represents a field for receiving the URL associated with the website 104.

As an example, as seen in the chatbot system dialog interface 112, the conversations included within message boxes 410a to 410g may relate to one context while the conversations included within message boxes 410h and 410i may relate to another context different from the context associated with the conversations included within message boxes 410a to 410g. The chatbot system 102 seamlessly allows switching context during an ongoing conversation of the user 106 with the chatbot system 102.

The speech to text engine 222 enables the chatbot system dialog interface 112 to present a textual representation of an audio input message or an audio response message. Similarly, the text to speech engine 220 enables the chatbot system dialog interface 112 to provide an audio representation of a textual input message or a textual response message. It shall be noted that, in some scenarios, the chatbot system dialog interface 112 provides the input messages and the response messages in both textual and audio forms.

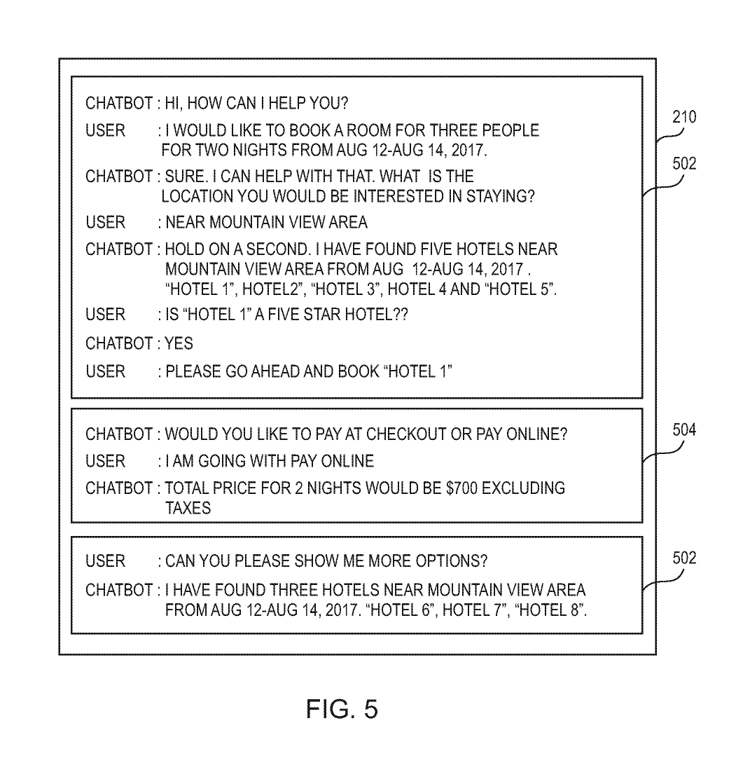

FIG. 5 is a simplified illustration of a stack of earlier conversations 210, in accordance with an example embodiment. The stack of earlier conversations 210 includes logs of historical conversations including past and ongoing conversations conducted between the user 106 and the chatbot 102. One or more contexts or topics are associated with the stack of earlier conversations 210. A current or an instant conversation input may relate to one or more contexts associated with the stack of earlier conversations 210. The probabilistic matching algorithm module 218 is configured to access the stack of earlier conversations 210 in order to detect a context, among the one or more contexts associated with the stack of earlier conversations 210, to which the conversation input is most likely to relate to. It shall be noted that a conversation may either define a single line of a conversation or multiple lines forming paragraphs of a conversation.

The processor 204 may arrange the conversations in the database 206 in a way such that the most recent conversation is stored as a last entry in the stack of earlier conversations 210. In an embodiment, the database 206 is configured to store a predefined number (say 10) of conversations in the stack of earlier conversations 210. In the illustrated example, two (2) conversations are shown in the stack of earlier conversations 210. For instance, conversations 502 and 504 denote two different contexts of the conversation. As an example, the context 502 relates to “hotel booking” and context 504 relates to “transportation”. It is further seen in FIG. 5 that the virtual agent system 102 seamlessly switches back to context 502 from context 504. In an embodiment, one or more conversations in the stack of earlier conversations 210 may relate to a single context.

In an embodiment, the probabilistic matching algorithm module 218 enables the chatbot system 102 to look up the stack of earlier conversations 210 to determine if an input relates to a new context or an ongoing context represented by the predefined number of conversations stored within the stack of earlier conversations 210. It is determined that an input relates to the ongoing context if the input received from user device 108 matches at least one context associated with the stack of earlier conversations 210. Upon detecting a match, the processor 204 thereby enables the virtual agent system 102 to determine an action to be performed by the virtual agent system 102. The action may be a response being sent to the user device 108, an activity being performed by the virtual agent system 102 or a combination of both. The response may be in the form of voice or text or both. The processor 204 may enable the chatbot system 102 to respond to the user 106 by posting questions, answering questions or posting additional questions in response to a question from the user 106.

The activity performed or to be performed by the virtual agent system 102. The activity may include, but not limited to, opening one or more pages, providing hyperlinks to a page or a website, opening one or more pop up interfaces, directing the user 106 to proceed to a payment page, automatically filling fields within a page with user details and providing a page with actionable icons, among others. The virtual agent system 102 may send response and perform the activity simultaneously.

The processor 204 further determines that an input relates to a new context if the input received from the user device 108 does not match or cannot be mapped to a context associated with the stack of earlier conversations 210. The processor 204 thereby enables the virtual agent system 102 to initiate a new conversation or determine the action to be performed.

In an embodiment, the processor 204 enables the chatbot system 102 to optionally request the user 106 involved in the conversation to modify an input message if the input could not be matched with one or more contexts in the stack of earlier conversations 210. The chatbot system 102 posts additional questions in response to an input message received from the user 106.

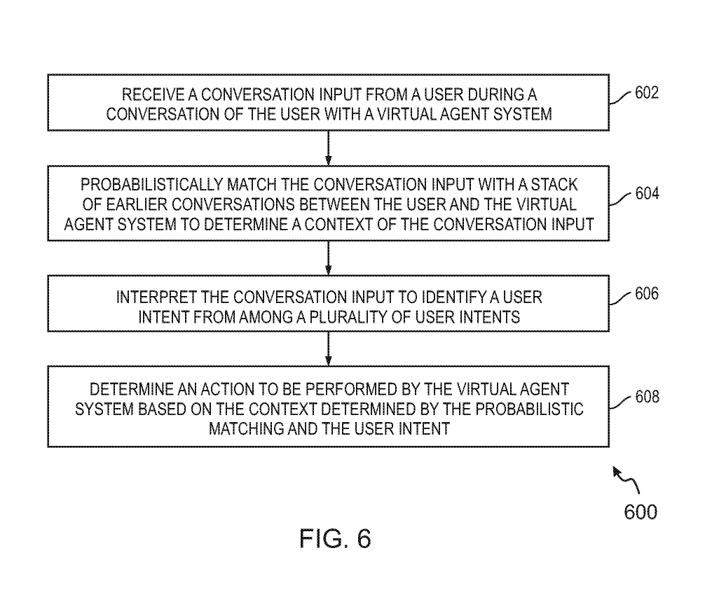

FIG. 6 is a flowchart 600 illustrating a method 600 conducting a conversation with the virtual agent system 102. The method 600 includes a sequence of operations. The operations of method 600 may be carried out by the virtual agent system 102. The sequence of operations of the method 600 may not be necessarily executed in the same order as they are presented. Further, one or more operations may be grouped together and performed in form of a single step, or one operation may have several sub-steps that may be performed in parallel or in sequential manner.

At operation 602, the virtual agent system 102 receives a conversation input from a user during a conversation of the user with the virtual agent system 102. At operation 604, the virtual agent system 102 probabilistically matches the conversation input with the stack of earlier conversations 210 between the user and the virtual agent system to determine a context of the conversation input. The context is determined from one or more contexts associated with the stack of earlier conversations 210. The processor 204 of the virtual agent system 102 enables the probabilistic matching algorithm module 218 to look up the stack of earlier conversations 210 to determine if an input relates to a new context or an ongoing context associated with the stack of earlier conversations 210. It is determined that an input relates to the ongoing context if the input received from user device 108 matches at least one context associated with the stack of earlier conversations 210. The processor 204 further determines that an input relates to a new context if the input received from user device 108 does not match or cannot be mapped to a context associated with the stack of earlier conversations 210.

At operation 606, the conversation input is interpreted to identify a user intent from among a plurality of user intents. The natural language processor 216 of the virtual agent system 102 parses the input messages and the intent model 208 interprets the user intent from the parsed data, wherein the identified user intent is one among the stored plurality of user intents. The intent model 208 further stores the input messages and the parsed data (data strings) corresponding to the input messages in the table 300 (shown in FIG. 3).

At operation 610, the virtual agent system 102 determines action to be performed by the virtual agent system 102 based on the context determined by the probabilistic matching and the user intent. The action may include a response to be sent by the virtual agent system 102 to the user device 108. The action may further include an activity to be performed by the virtual agent system 102.

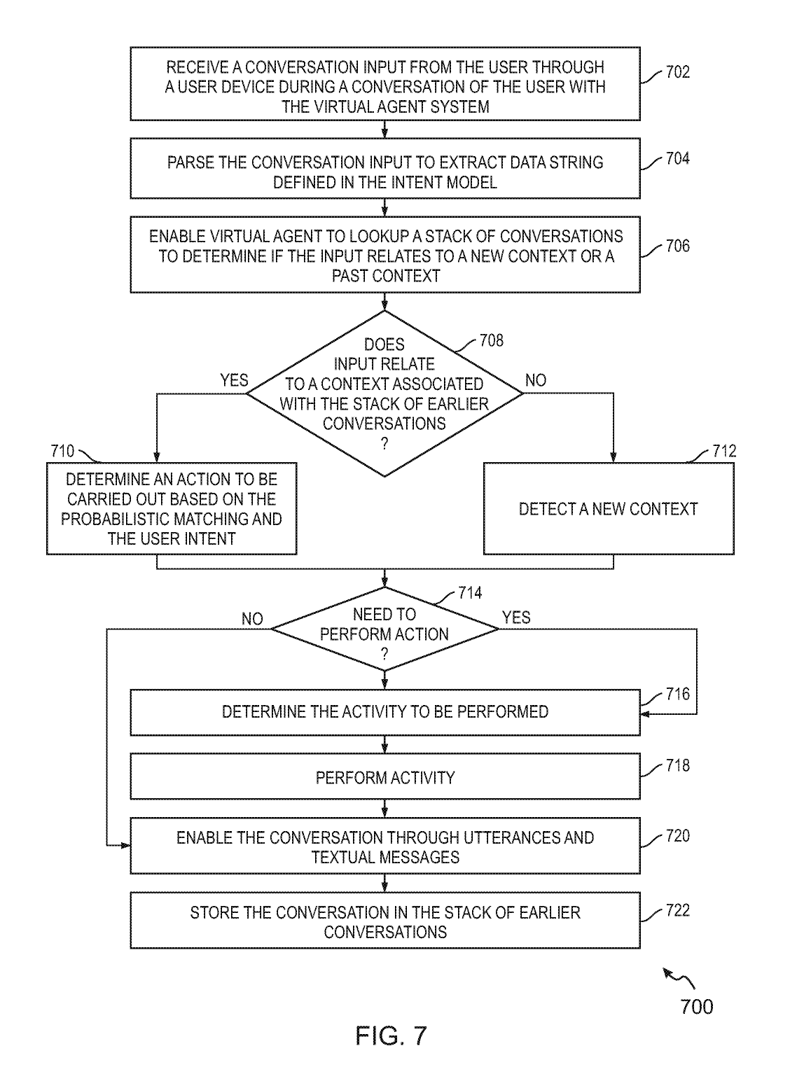

FIG. 7 illustrates another flowchart showing an example method 700 for conducting a conversation with the virtual agent system 102. The method 700 includes a sequence of operations. The operations of method 700 may be carried out by the virtual agent system 102. The sequence of operations of the method 700 may not be necessarily executed in the same order as they are presented. Further, one or more operations may be grouped together and performed in form of a single step, or one operation may have several sub-steps that may be performed in parallel or in sequential manner.

At operation 702, a virtual agent system such as the virtual agent system 102 receives a conversation input from the user 106 through a user device such as the user device 108 during a conversation of the user with the virtual agent system 102. At operation 704, the input message is parsed, for example by the natural language processor 216 of the virtual agent system 102. Parsing may be performed based on a set of instructions or rules to extract data strings from the conversation input. The data strings may be defined and stored in the intent model 208. The parsed data may be used to interpret the conversation input to identify a user intent by an intent model such as the intent model 208. The input message, the parsed data corresponding to the input message and the user intent may be stored in the intent model 208. At operation 706, the virtual agent system, enables a probabilistic matching algorithm module such as the module 218 to look up a stack of earlier conversations (e.g., the stack of earlier conversations 210) to determine if the conversation input relates to a new context or a past context. At operation 708, it is determined if the conversation input relates to a context associated with the stack of earlier conversations 210. If it is determined that the input relates to a context associated with the stack of earlier conversations 210, then at operation 710, the virtual agent system 102 determines an action to be carried out based on the probabilistic matching (performed at operation 706) and the user intent. If it is determined that the input does not relate to a context associated with the stack of earlier conversations 210, a new context is detected at operation 712. At operation 714, it is further determined if an activity needs to be performed. If it is determined that an activity needs to be performed, then at operation 716, the virtual agent system 102 determines the activity, and subsequently perform the activity at operation 718. If it is determined that an activity need not to be performed, then at operation 720, the virtual agent system 102 enables the conversation through utterances and textual messages. Further, at operation 722, the virtual agent system 102 stores the conversation in the stack of earlier conversations 210.

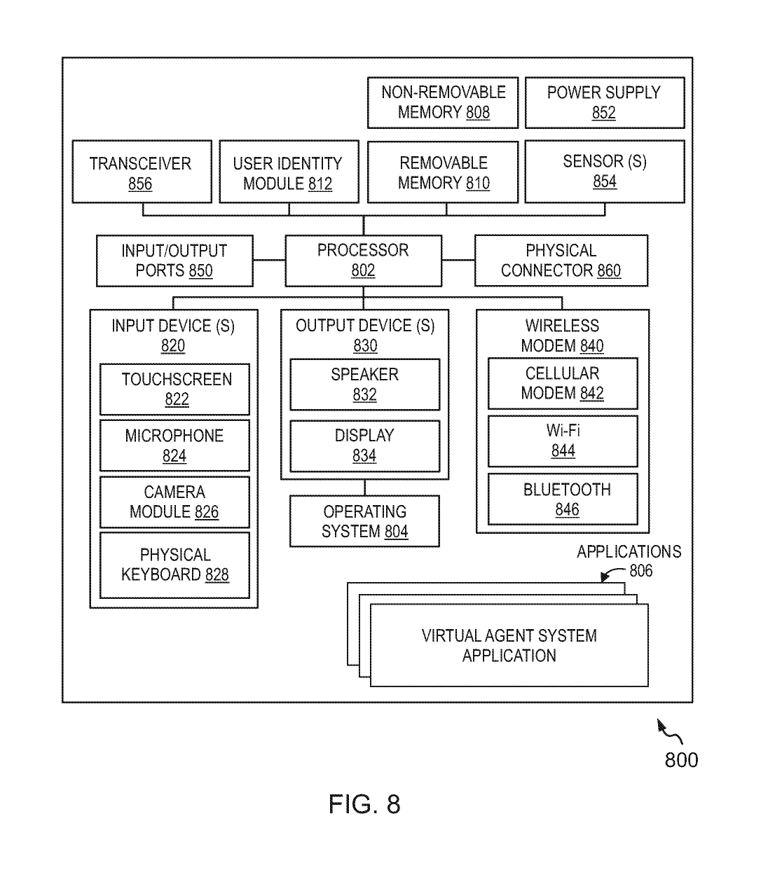

FIG. 8 shows a simplified block diagram of a user device for example a mobile phone 800 capable of implementing the various embodiments of the present disclosure. The user device 800 may be an example of user device 108. In an embodiment, the various operations related to conducting a conversation with a virtual agent system 102 can be facilitated using a virtual agent system application 806 (stand alone application) installed in the mobile phone 800.

It should be understood that the mobile phone 800 as illustrated and hereinafter described is merely illustrative of one type of device and should not be taken to limit the scope of the embodiments. As such, it should be appreciated that at least some of the components described below in connection with that the mobile phone 800 may be optional and thus in an example embodiment may include more, less or different components than those described in connection with the example embodiment of the FIG. 8. As such, among other examples, the mobile phone 800 could be any of a mobile electronic devices or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated mobile phone 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the mobile phone 800 and support for one or more applications programs (see, virtual agent system application 806). The virtual agent system application 806 may include common mobile computing applications (e.g., web browsers, messaging applications) or any other computing application.

The illustrated mobile phone 800 includes one or more memory components, for example, a non-removable memory 808 and/or removable memory 810. The non-removable memory 808 and/or removable memory 810 may be collectively known as database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the virtual agent system application 806. The mobile phone 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The mobile phone 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the mobile phone 800 and a public switched telephone network (PSTN).

The mobile phone 800 can further include one or more input/output ports 850, a power supply 852, one or more sensors 854 for example, an accelerometer, a gyroscope, a compass, or an infrared proximity sensor for detecting the orientation or motion of the mobile phone 800, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

The disclosed methods with reference to FIGS. 1 to 7, or one or more operations of the flow diagram 600 and 700 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

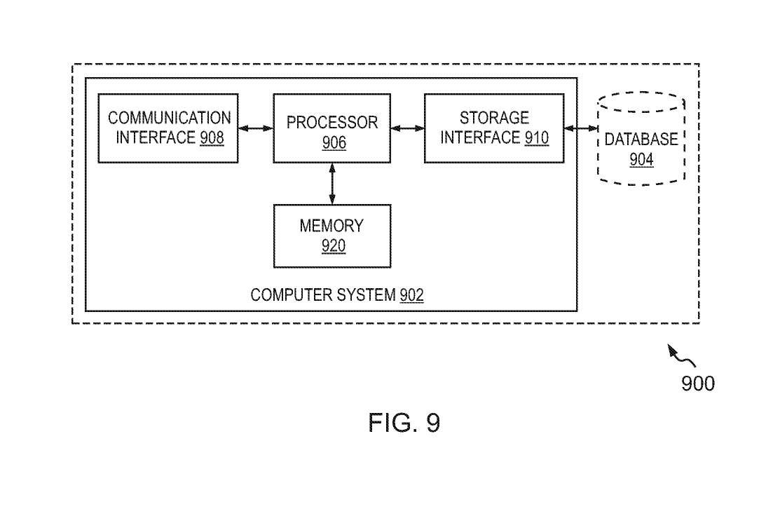

FIG. 9 is a simplified block diagram of a server system 900, in which the virtual agent system 102 may be stored, in accordance with one embodiment of the present disclosure. The server system 900 includes a computer system 902 and one or more databases such as a database 904. The database 904 may be an example of the database 206.

The computer system 902 includes a processor 906 for executing instructions. The processor 906 may be an example of the processor 204. Instructions may be stored in, for example, but not limited to, a memory 908 (example of memory 202). The processor 906 may include one or more processing units (e.g., in a multi-core configuration). The processor 906 is operatively coupled to a communication interface 908 such that computer system 902 is capable of communicating with the user device 108.

The processor 906 may also be operatively coupled to the database 904. The database 904 is any computer-operated hardware suitable for storing and/or retrieving data. The database 904 may include multiple storage units such as hard disks and/or solid-state disks in a redundant array of inexpensive disks (RAID) configuration. The database 1104 may include, but not limited to, a storage area network (SAN) and/or a network attached storage (NAS) system.

In some embodiments, the database 904 is integrated within computer system 902. For example, computer system 902 may include one or more hard disk drives as database 904. In other embodiments, database 904 is external to computer system 902 and may be accessed by the computer system 902 using a storage interface 910. The storage interface 910 is any component capable of providing the processor 906 with access to the database 904. The storage interface 910 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 906 with access to the database 904.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application \or implementation without departing from the spirit or scope of the claims.

What is claimed is:

1. A computer-implemented method for conducting a conversation with a virtual agent system, the method comprising:
receiving a conversation input from a user during a conversation of the user with a virtual agent system;
probabilistically matching the conversation input with a stack of earlier conversations between the user and the virtual agent system to determine a context of the conversation input, the context determined from one or more contexts associated with the stack of earlier conversations;
interpreting the conversation input to identify a user intent from among a plurality of user intents; and
determining an action to be performed by the virtual agent system based on the context determined by the probabilistic matching and the user intent.

2. The method as claimed in claim 1, wherein determining the action comprises determining a response of the virtual agent system to the conversation input received from the user during the conversation.

3. The method as claimed in claim 2, further comprising sending the response of the virtual agent system to a user device associated with the user.

4. The method as claimed in claim 1, wherein determining the action comprises determining an activity to be performed by the virtual agent system in response to the conversation input received from the user during the conversation.

5. The method as claimed in claim 1, wherein determining the action further comprises determining that the conversation input corresponds to an ongoing context if the conversation input matches at least one context among the one or more contexts associated with the stack of earlier conversations and perform at least one of:
sending a response to a user device associated with the user; and
performing an activity.

6. The method as claimed in claim 1, wherein determining the action further comprises determining that the conversation input relates to a new context if the conversation input does not match the one or more contexts associated with the stack of conversations and perform at least one of:
sending a response to a user device associated with the user; and
performing an activity.

7. The method as claimed in claim 1, wherein the conversation input is a voice input.

8. The method as claimed in claim 1, wherein the conversation input is a text input.

9. The method as claimed in claim 1, wherein interpreting the conversation input to identify the user intent comprises parsing the conversation input to extract one or more data strings defined in at least one intent model storing the plurality of user intents.

10. The method as claimed in claim 1, wherein probabilistically matching the conversation input with the stack of earlier conversations comprises enabling the virtual agent system to lookup the stack of earlier conversations.

11. The method as claimed in claim 1, further comprising enabling the virtual agent system to request the user to modify the conversation input.

12. A system for conducting an automated conversation with a virtual agent system, the system comprising:
a memory configured to store instructions and at least one intent model; and
a processor configured to execute the stored instructions to cause the system to at least perform:
receiving a conversation input from a user during a conversation of the user with a virtual agent system;
probabilistically matching the conversation input with a stack of earlier conversations between the user and the virtual agent system to determine a context of the conversation input, the context determined from one or more contexts associated with the stack of earlier conversations;
interpreting the conversation input to identify a user intent from among a plurality of user intents; and
determining an action to be performed by the virtual agent system based on the context determined by the probabilistic matching and the user intent.

13. The system as claimed in claim 12, wherein for determining the action, the system is further caused at least in part to determine response of the virtual agent system to the conversation input received from the user during the conversation.

14. The system as claimed in claim 12, wherein for determining the action, the system is further caused at least in part to determine an activity to be performed by the virtual agent system in response to the conversation input received from the user during the conversation.

15. The system as claimed in claim 12, wherein for interpreting the conversation input to identify the user intent, the system is further caused at least in part to, parse the conversation input to extract one or more data strings defined in the at least one intent model.

16. The system as claimed in claim 12, wherein for probabilistically matching the conversation input with the stack of earlier conversations, the system is further caused at least in part to:
determine that the conversation input relates to an ongoing context if the conversation input matches at least one context among the one or more contexts associated with the stack of earlier conversations; and
perform at last one of:
sending a response to a user device associated with the user; and
performing an activity.

17. The system as claimed in claim 12, wherein for probabilistically matching the conversation input with the stack of earlier conversations, the system is caused at least in part to:
determine that the conversation input relates to a new context if the conversation input does not match the one or more contexts associated with the stack of earlier conversations; and
perform at last one of:
sending a response to a user device associated with the user; and
performing an activity.

18. The system as claimed in claim 12, wherein the system is further caused to enable the virtual agent system to request the user to modify the conversation input.

19. The system as claimed in claim 12, further comprising a machine learning module configured to train the intent model on a plurality of conversation inputs received from a plurality of users through a plurality of user devices.

20. A computer program product including a computer readable storage medium and including computer executable code for a virtual agent system, the computer executable code being executed by a processor, the computer program product comprising one or more instructions, the instructions causing the virtual agent system to:
receive a conversation input from a user during a conversation of the user with a virtual agent system;
probabilistically match the conversation input with a stack of earlier conversations between the user and the virtual agent system to determine a context of the conversation input, the context determined from one or more contexts associated with the stack of earlier conversations;
interpret the conversation input to identify a user intent from among a plurality of user intents; and
determine an action to be performed by the virtual agent system based on the context determined by the probabilistic matching and the user intent.
